(19) United States
(12) Patent Application Publication
(10) Pub. No.: US 2014/0074848 A1
(43) Pub. Date: Mar. 13, 2014

(54) DYNAMIC FRAMEWORK FOR PSYCHOMETRIC TESTING

(71) Applicants: Juha Kettunen, Kangasala (FI); Oula Jarvinen, Espoo (FI)

(72) Inventors: Juha Kettunen, Kangasala (FI); Oula Jarvinen, Espoo (FI)

(73) Assignee: Reflect Career Partners Oy, Helsinki (FI)

(21) Appl. No.: 14/117,022

(22) PCT Filed: May 13, 2011
(86) PCT No.: PCT/FI11/50441

§ 371 Date: Nov. 11, 2013

(51) Int. Cl. G06F 17/30

(52) U.S. Cl. CPC G06F 17/30598
USPC 707/740

(57) ABSTRACT

A method of psychometric testing is disclosed. Input from a plurality of users is received. The input is indicative of first and second psychometric variables, where the first and second psychometric variables are independent. The input allows classifying users into at least four classes using a first classification threshold for the first psychometric variable and a second classification threshold for the second psychometric variable. The classification thresholds are adjustable so that the classification of users into classes is altered so that a user is re-classified to a different class. The questions in the input questionnaire may also be changed, and they may e.g. be translated to another language. Furthermore, the system generates textual output based on the classification, and the users may be allowed to vote on the output descriptions.

### BACKGROUND

1. Field

The aspects of the disclosed embodiments relate to a method of carrying out psychometric testing, for producing output from the same, as well as to a method of forming a psychometric testing framework, and also relate to devices, systems, computer program products, services and data structures for the same.

2. Brief Description of Related Developments

There exist a myriad of psychometric tests for analyzing the behavior and preferences of healthy and normal human beings. These tests may be targeted towards different purposes, for example personality testing at workplace. Some of these tests are very specific to the application, and some may have wider applicability. The tests are static in nature, that is, a test that has once been designed cannot be altered to a different form without losing reliability. The tests may produce textual output e.g. so that a certain personality type always spawns a certain textual description of the type. The tests may also not be suited for application under different conditions such as different stress level, depending on how the test has been designed. It may also be difficult to apply the test results to practical everyday life and work situations. Furthermore, the tests may not be readily available for all needs due to their proprietary nature and possibly high fees, which results from the high costs of assembling a good set of questions and the test population, and from drafting a useful set of answers.

There is, therefore, a need for a solution that alleviates at least some of the rigid limitations of the currently available psychometric tests and makes it easier to design and/or apply tests in a practical setting.

### SUMMARY

Now there has been invented an improved method and technical equipment implementing the method, by which the above problems are alleviated. Various aspects of the disclosed embodiments include a method, an apparatus, a server, a client and a computer readable medium comprising a computer program stored therein, which are characterized by what is stated in the independent claims. Various embodiments of the invention are disclosed in the dependent claims.

One embodiment relates to adjusting a psychometric test, and to carrying out psychometric testing, as well as the corresponding data structures, computer program products, devices and systems. Input from a plurality of users is received, for example by means of a questionnaire. The input is indicative of a first psychometric variable and a second psychometric variable, where the first and the second psychometric variables being essentially independent from each other. The input allows classifying users into at least four classes using at least a first classification threshold for the first psychometric variable and at least a second classification threshold for the second psychometric variable. The classification thresholds for the classes (and possible sub-classes) are adjustable so that the classification of users into said classes is altered so that at least one user is re-classified to a different class. The questions in the input questionnaire may also be changed, and they may e.g. be translated to another language. Furthermore, the system generates textual output based on the classification, and the users may be allowed to vote on the output descriptions. This way, descriptions that are not appreciated by the users may be pushed down in the presentation priority. The above adjustments may take place by comparison to another population and/or test, by targeted adjustment of the classification to reach a desired class and sub-class distribution, and/or based on user feedback (e.g. voting).

According to a first embodiment, there is provided a method for adjusting a psychometric test, the method comprising receiving input from a plurality of users, the input being indicative of a first psychometric variable and a second psychometric variable, the first and the second psychometric variables being essentially independent from each other, classifying said users into at least four classes using said input and at least a first classification threshold for a first psychometric variable and at least a second classification threshold for a second psychometric variable, and adjusting said first classification threshold to adjust the classification of said users into said classes so that at least one user is re-classified to a different class.

According to an embodiment, the method comprises receiving said input from a plurality of users as responses to questions, receiving modified input from at least one user as responses to modified questions, adjusting said first classification threshold for user in association to receiving said modified input. According to an embodiment, the method comprises modifying said questions by way of at least one of the group of translating a question to another language, re-wording an existing question, adding a question and deleting question. According to an embodiment, the method comprises defining at least one sub-threshold for said first psychometric variable for forming sub-classes, said sub-threshold being different than said threshold, and classifying said users to said sub-classes using said sub-threshold. According to an embodiment, the method comprises presenting a plurality of descriptions to at least one said user according to said classification of said user into a class or a sub-class, receiving a response from said at least one said user corresponding to a description, and altering the priority of presentation of said description based on said response. According to an embodiment, the priority of presentation of said description is altered for other users. According to an embodiment, the priority of presentation of said description is altered for other users having at least one of the group of the same class, the same sub-class and the same language. According to an embodiment, the adjusting is carried out by comparing said classification of users to another known classification of users.

According to a second embodiment, there is provided a data structure for psychometric testing embodied on a computer readable medium, said data structure comprising data elements for controlling a computer to receive input from a plurality of users, the input being indicative of a first psychometric variable and a second psychometric variable, the first and the second psychometric variables being essentially independent from each other, and to classify said users into at least four classes using said input and at least an adjusted first classification threshold for a first psychometric variable and at least a second classification threshold for a second psychometric variable, wherein said adjusted first classification threshold having been adjusted to adjust classification of said users into said classes so that at least one user is re-classified to a different class than without said adjustment of said first classification threshold, wherein said data structure having been adjusted based on input from users.

According to an embodiment, the data structure comprises descriptions associated with said classes for presenting said descriptions to said users, and priority of presentation values for said descriptions, said priority of presentation values having been formed based on input from users.

According to a third embodiment, there is provided a computer program product embodied on a computer readable medium, comprising computer program code which, when executed on a processor, causes a computer or a system to receive input from a plurality of users, the input being indicative of a first psychometric variable and a second psychometric variable, the first and the second psychometric variables being essentially independent from each other, classify said users into at least four classes using said input and at least a first classification threshold for a first psychometric variable and at least a second classification threshold for a second psychometric variable, and adjust said first classification threshold to adjust the classification of said users into said classes so that at least one user is re-classified to a different class.

According to a fourth embodiment, there is provided a system for adjusting a psychometric test, comprising a computer configured to receive input from a plurality of users, the input being indicative of a first psychometric variable and a second psychometric variable, the first and the second psychometric variables being essentially independent from each other, a computer configured to classify said users into at least four classes using said input and at least a first classification threshold for a first psychometric variable and at least a second classification threshold for a second psychometric variable, a computer configured to adjust said first classification threshold to adjust the classification of said users into said classes so that at least one user is re-classified to a different class.

According to a fifth embodiment, there is provided a method for psychometric testing, comprising receiving input from a plurality of users, the input being indicative of a first psychometric variable and a second psychometric variable, the first and the second psychometric variables being essentially independent from each other, classifying said users into at least four classes using said input and at least a first classification threshold for a first psychometric variable and at least a second classification threshold for a second psychometric variable, presenting a plurality of descriptions to at least one said user according to said classification of said user into a class, receiving a response from said at least one said user corresponding to a description, and altering the priority of presentation of said description based on said response.

According to an embodiment, the priority of presentation of said description is altered for other users. According to an embodiment, the priority of presentation of said description is altered for other users having at least one of the group of the same class, the same sub-class and the same language. According to an embodiment, the method comprises defining at least one sub-threshold for said first psychometric variable for forming sub-classes, said sub-threshold being different than said threshold, classifying said users to said sub-classes using said sub-threshold. According to an embodiment, the method comprises forming a collaboration description based on a classification of a first said user and a second said user, and presenting said collaboration description to said first user. According to an embodiment, the method comprises determining a team role preference for a group of said users based on said classification, said group of said users comprising a first, second and a third user, providing an association of said first user to a first team role based on a first preference of said first user to said first team role, and providing an association of said second user to a second team role based on said second user having a higher second preference to said second team role compared to a second preference of said third user to said second team role, wherein said second user has a higher first preference to said first team role compared to the second preference to said second team role.

According to a sixth embodiment, there is provided a computer program product embodied on a computer readable medium, comprising computer program code which, when executed on a processor, causes a computer or a system to carry out the method according to the fifth embodiment.

According to a seventh embodiment, there is provided a system for psychometric testing, comprising means for receiving input from a plurality of users, the input being indicative of a first psychometric variable and a second psychometric variable, the first and the second psychometric variables being essentially independent from each other, means for classifying said users into at least four classes using said input and at least a first classification threshold for a first psychometric variable and at least a second classification threshold for a second psychometric variable, means for presenting a plurality of descriptions to at least one said user according to said classification of said user into a class, means for receiving a response from said at least one said user corresponding to a description, and means for altering the priority of presentation of said description based on said response.

According to an eighth embodiment, there is provided a system for psychometric testing, comprising at least one computer and at least one user terminal in a network setting, said system comprising computer program code that, when executed, causes said computer and said at least one user terminal to receive input from a plurality of users, the input being indicative of a first psychometric variable and a second psychometric variable, the first and the second psychometric variables being essentially independent from each other, classify said users into at least four classes using said input and at least a first classification threshold for a first psychometric variable and at least a second classification threshold for a second psychometric variable, present a plurality of descriptions to at least one said user according to said classification of said user into a class, receive a response from said at least one said user corresponding to a description, and alter the priority of presentation of said description based on said response.

According to a ninth embodiment, there is provided a system for psychometric testing, comprising at least one computer and at least one user terminal in a network setting, said system comprising computer program code that, when executed, causes said computer and said at least one user terminal to carry out the method according to the fifth embodiment.

According to a tenth embodiment, there is provided a network service embodied on at least one computer in a networked setting, said network service being, when requested by a user, configured to receive input from a plurality of users, the input being indicative of a first psychometric variable and a second psychometric variable, the first and the second psychometric variables being essentially independent from each other, classify said users into at least four classes using said input and at least a first classification threshold for a first psychometric variable and at least a second classification threshold for a second psychometric variable, present a plurality of descriptions to at least one said user according to said classification of said user into a class, receive a response from said at least one said user corresponding to a description, alter the priority of presentation of said description based on said response.

### BRIEF DESCRIPTION OF THE DRAWINGS

In the following, various embodiments will be described in more detail with reference to the appended drawings, in which

FIG. 1 shows a structure of a psychometric testing framework according to an example embodiment;

FIG. 2a shows a flow chart of carrying out a psychometric test according to an example embodiment;

FIG. 2b shows an example set of questions for a psychometric test according to an example embodiment;

FIGS. 3a and 3b illustrate dynamically adjustable class thresholds for a psychometric test according to an example embodiment;

FIG. 4a shows a flow chart of producing adjustable output from a psychometric test according to an example embodiment;

FIG. 4b shows a user interface for adjusting output from a psychometric test according to an example embodiment;

FIG. 5a shows a data structure for producing adjustable output from a psychometric test according to an example embodiment;

FIG. 5b shows an example of data in a data structure for producing adjustable output from a psychometric test according to an example embodiment;

FIG. 5c shows an example of an output for applying psychometric testing for interaction according to an example embodiment;

FIG. 6 shows a method of assigning people to team roles based on psychometric testing according to an example embodiment; and

FIG. 7 shows a system and devices for psychometric testing according to an example embodiment.

### DETAILED DESCRIPTION OF THE EMBODIMENTS

In the following, several embodiments of the invention will be described in the context of carrying out psychometric testing and using certain example classifications. It is to be noted, however, that the invention is not limited to such testing, and especially not limited to the example classifications. In fact, the different embodiments may have applications in any environment where adjustment of the testing framework of a statistical test is required, and in any psychometric testing with any classification setup.

It has been noticed in the disclosed embodiments that psychometric testing is sensitive to changes in the setup of the testing and may produce erroneous output if the changes in the setup are not compensated. On the other hand, it has also been noticed that established psychometric tests may not be accurate and sensitive enough, and modification of the tests would be desirable. However, there has not existed a method for adjusting the test to produce desirable output (classification results and feedback) that the users are willing to accept.

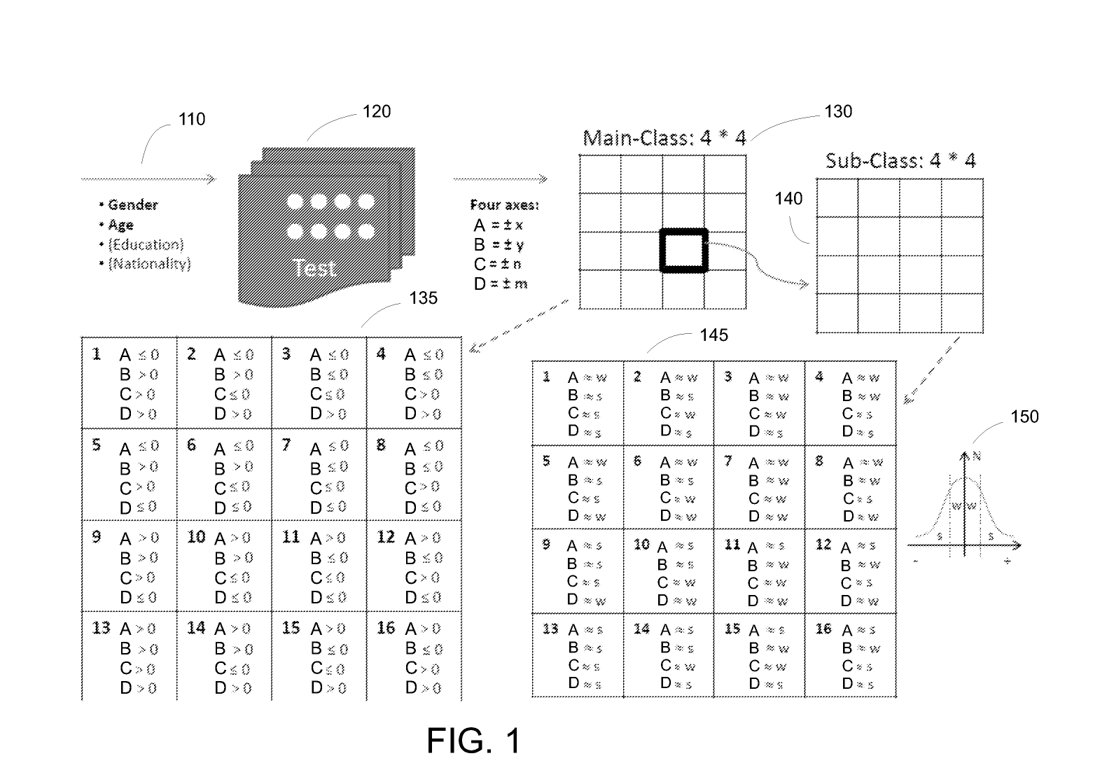

FIG. 1 shows a structure of a psychometric testing framework according to an example embodiment. In the test, a user may give background information such as gender, age, education information, nationality, language etc in phase 110. This background information may be used for other purposes in the system, or it may be at least partially used e.g. in producing the output for the user. For example, the age may affect the output of the system, and the language information may be used to decide in which language the feedback is given. In the testing phase 120, the user may be asked a number of questions and/or presented a number of sentences, and the system may then receive user input in response to these. The input may be in the form of multiple choice selection e.g. one of the selections “completely disagree”, “disagree”, “agree” and “completely agree”.

In phase 130, the input given by the user is evaluated and scores for one, two, three, four or more psychometric variables (or dimensions) are calculated. This may happen e.g. so that each answer gives either negative or positive values for a certain individual axis (variable). The values from different questions are then summed for each individual axis. The summing may happen directly or so that the answers are weighted so that some answers are more dominant in the resulting sum value. In other words, a projection of the answers onto different psychometric dimensions is calculated, either directly or as a weighted sum of vector projections. In the summing, the weighting of the answers may be applied for all dimensions, or the weighting may be applied differently to different dimensions. The weighting may be applied linearly so that the points/scores for each answer are multiplied by a coefficient. For example, if the original score on an axis is 0.3, the weighted score may be 0.6, and for a score of 0.8, the weighted score may be 1.6. Alternatively or in addition, the weighting may be applied non-linearly so that the score on a dimension/axis is computed as a function of the original answer score. For example, if the original score projected on an axis is 0.3, the weighted score may be 0.9 (from 10*score*score=10*0.3*0.3), and for a score of 0.8, the weighted score may be 6.4 (from 10*score*score=10*0.8*0.8). Preferably, the evaluation and summing is carried out for at least two axes (variables) so that at least four classes can be formed by dividing the axes into two parts by using a classification threshold.

In FIG. 1, four axes/dimensions (A, B, C and D) are used, resulting in 16 classes 130 when one threshold value per axis is used, or in 256 classes and sub-classes 140 when one threshold value and two sub-threshold values per axis are used (dividing each axis into four parts). Each of the different classes 135 contain users whose score on each of the four psychometric axes is below or above the threshold, according to the class. For example, class 11 in classification 135 contains users who have an A value above the threshold (in FIG. 1, the A threshold has a value zero, but may also have another value), and who have the B, C and D value below the respective thresholds. As shown in FIG. 1, the main classes 135 may be further divided into sub-classes by using threshold values. For example, in the sub-class 13, all of the A, B, C, D values are high in magnitude, meaning that for example the main class 11 and sub-class 13 the A value is very high and the B, C, D values are very low (highly negative). Depending on how the thresholds and sub-thresholds are set, the user population N is divided into classes and sub-classes differently, as illustrated by the distribution 150.

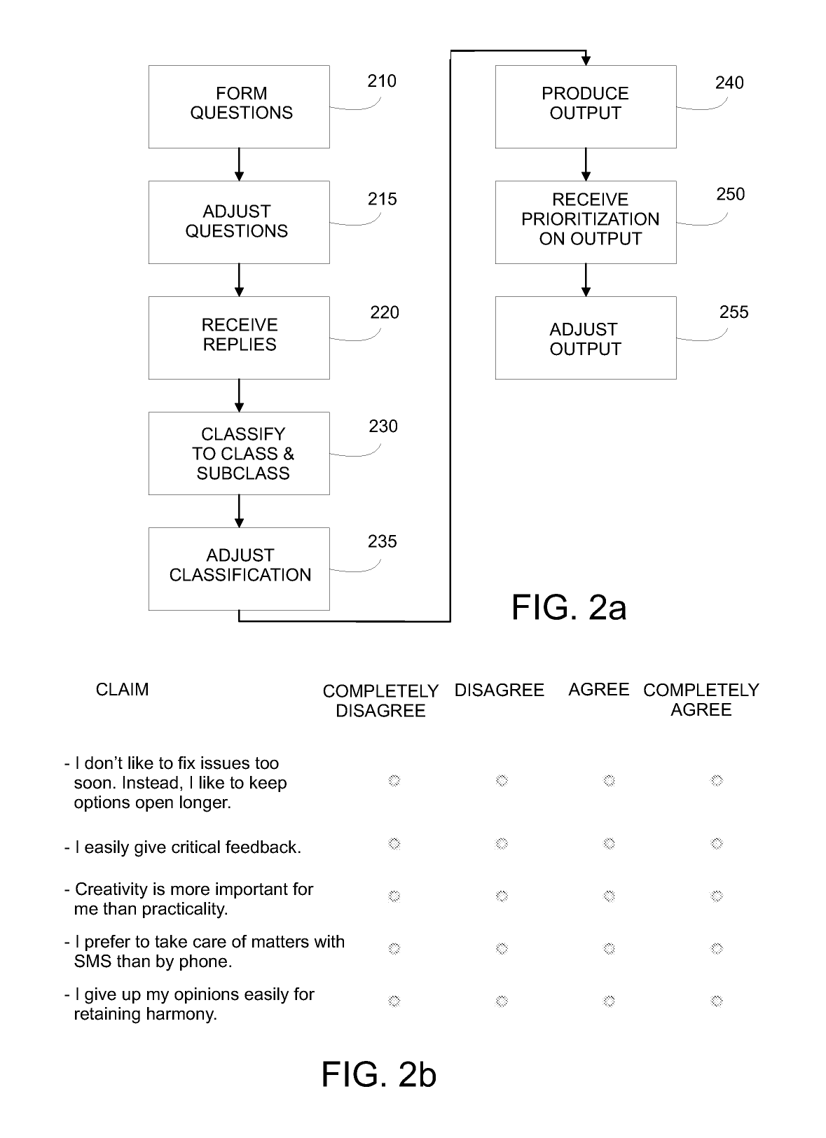

FIG. 2a shows a flow chart of carrying out a psychometric test according to an example embodiment. In phase 210, the questions to be presented to a user are formed. The questions may be taken from a fixed bank of questionnaire (even the same questions may be used always), or they may be selected randomly or with some algorithm from a pool of questions. Depending on the situation, the user and the desired performance of the psychometric test, the questions may be adjusted in phase 215. For example, the questions may be translated to another language (or questions in another language may be selected) or the tone of the questions may be changed to less or more assertive.

In phase 220, the replies from the user are received. The receiving may be arranged by means of a standalone or a client program running on the user's computer, or for example using a browser to access a network service. The questions may be presented to the user in groups or one by one. As explained earlier, the answers may then be used in phase 230 to classify the user into a class and possibly a sub-class. In phase 235, the classification for the user (and possibly for other users) may be adjusted so that the user is re-classified into a different class and/or sub-class. The adjustment may be done based on the classification of a number of users, using another (reference) classification, based on a desired output, based on user feedback etc. The adjustment may take place by changing the threshold values for the main classes and sub-classes. For example, the threshold for a main class in one dimension may be made smaller or larger, and alternatively or in addition, the thresholds for the sub-classes may be changed to be smaller or larger. This shifting of thresholds may result in the user being classified into a different class or sub-class. The adjustment may also be done by changing the weightings or projections of the answers onto the different psychometric axes.

In phase 240, output to the user may be produced. This output may be in the form of an electronic visual report, a paper report, an audible report, a tailored program/application for the user's personal computer or portable electronic device, or in the form of a psychologist's consultation, or a combination of any or all of these. The output may comprise providing the user's classification into a class and a sub-class, providing information on the user's preference of team roles, providing information on collaboration behavior with another user, providing descriptions on the user's typical behavior in different situations, and so on. In phase 250, the user may give feedback on the produced output, for example by choosing items or descriptions that he finds to have a good match with his behavior, or choosing away items that he finds less matching. In this way, the user can even further adjust the classification results. The user's feedback may be utilized in phase 255 so that the items that the user chose not to be a good description of his behavior are not shown to the user any more. Such items may also be lowered in priority so that they are not shown to other users, either, or that they are shown with a smaller probability. In other words, the user may affect the presentation priority of an output item both for himself and for other users. Alternatively or in addition, items may be voted by the user to have a high match, and their presentation priority may be increased so that they are shown to the user. The presentation priority may be dependent e.g. on the class, on the sub-class and on the language of each description. There may be one or more classes and sub-classes for the same description (as will be explained later).

FIG. 2b shows an example set of questions for a psychometric test according to an example embodiment. The questions 280 may be shown individually or in groups. The user may be able to choose from a number of different answers 290 (in the manner of multiple-choice questions), for example among “completely disagree”, “disagree”, “agree” and “completely agree”. The user may be able to choose only one of the answers, or he may be able to choose multiple answers. The user may also input his answer textually, using a slider on the display, verbally with the help of speech recognition or with any other input means.

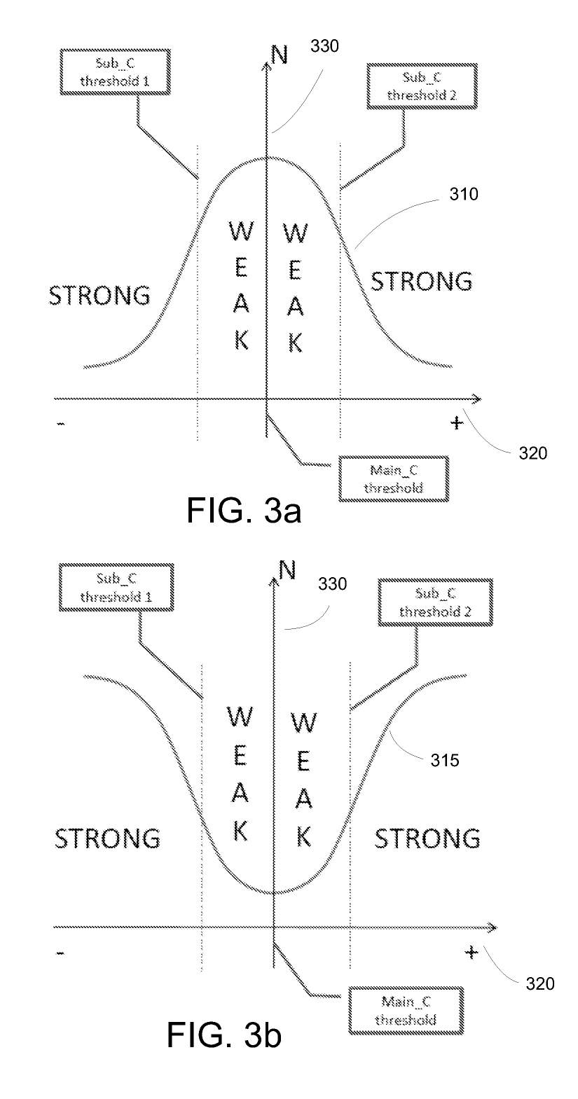

FIGS. 3a and 3b illustrate dynamically adjustable class thresholds for a psychometric test according to an example embodiment. In FIG. 3a, the distribution 310 of users in one psychometric dimension 320 is shown. The number N 330 of the users having a certain value on the psychometric axis is in this case larger close to the middle of the axis and close to the main threshold Main_C. Therefore, a small change in the threshold Main_C value may result in a fairly large number of users being classified to a different class. The threshold value Main_C may be zero or it may deviate from zero. It has been noticed in the disclosed embodiments that such a bell-shaped distribution of users may be common in the commonly available psychometric tests. It has further been noticed that due to a large number of users being distributed around the main classification threshold, the reliability of the classification may be poor in the known psychometric tests. In other words, even small changes in how users respond to the questions may have a large impact on the classification frequencies of the whole population. The aspects of the disclosed embodiments overcome this problem e.g. so that the classification threshold may be adjustable, and the adjustment may be used to compensate for any classification discrepancies compared to a known classification.

In FIG. 3b yet another embodiment is illustrated. The psychometric test according to the disclosed embodiments may be adjusted so that the distribution 315 of users is more polarized than in FIG. 3a. In other words, the questions may be designed and adjusted so that users are more likely to give extreme replies, leading to a distribution that can be distinguished between classes more reliably. Alternatively or in addition to this, the questions and replies may be weighted so that for one or more axes those questions and replies are given a higher weight that best distinguish the users between classes, and/or the questions and replies that distinguish users poorly between classes may be suppressed or removed altogether from the classification for one or more axes. Both the adjustment and weighting of questions and replies may lead to a more pronounced distribution of users into classes. The adjustment and/or weighting may happen manually, or it may happen based on the replies from users, the determined class distribution, or user feedback to the descriptions produced by the system. The main classification threshold can be adjusted to fine-tune classification between the classes, but now a small change in the classification threshold leads to a much smaller number of users being re-classified to another class.

In FIGS. 3a and 3b, the sub-class thresholds Sub_C threshold 1 and Sub_C threshold 2 may be used to further classify users into sub-classes. A sub-class threshold may be used to divide users to those having a strong (s) preference for a class and to those having a weak (w) preference to a class. The absolute values of the Sub_C threshold 1 and Sub_C threshold 2 may be the same, but they may also be different. The sub-class thresholds may be set so that only a small number of users will be classified to have a strong preference, or so that a large number of users will be considered to have a strong preference for the class, or somewhere in the middle. If there are altogether 3 thresholds for a single psychometric axis, and there are 4 different axes, the number of classes and sub-classes is 256.

There may be a larger number of main class thresholds than one, for example 2, 3, 4 or 5, and for each class there may be a larger number of sub-class thresholds than one, for example 2, 3, 4 or 5. There may also be only three classes and no sub-classes, meaning that there are only two main class thresholds and no sub-class thresholds. The main class thresholds may be e.g. at the positions of the Sub_C thresholds of FIGS. 3a and 3b.

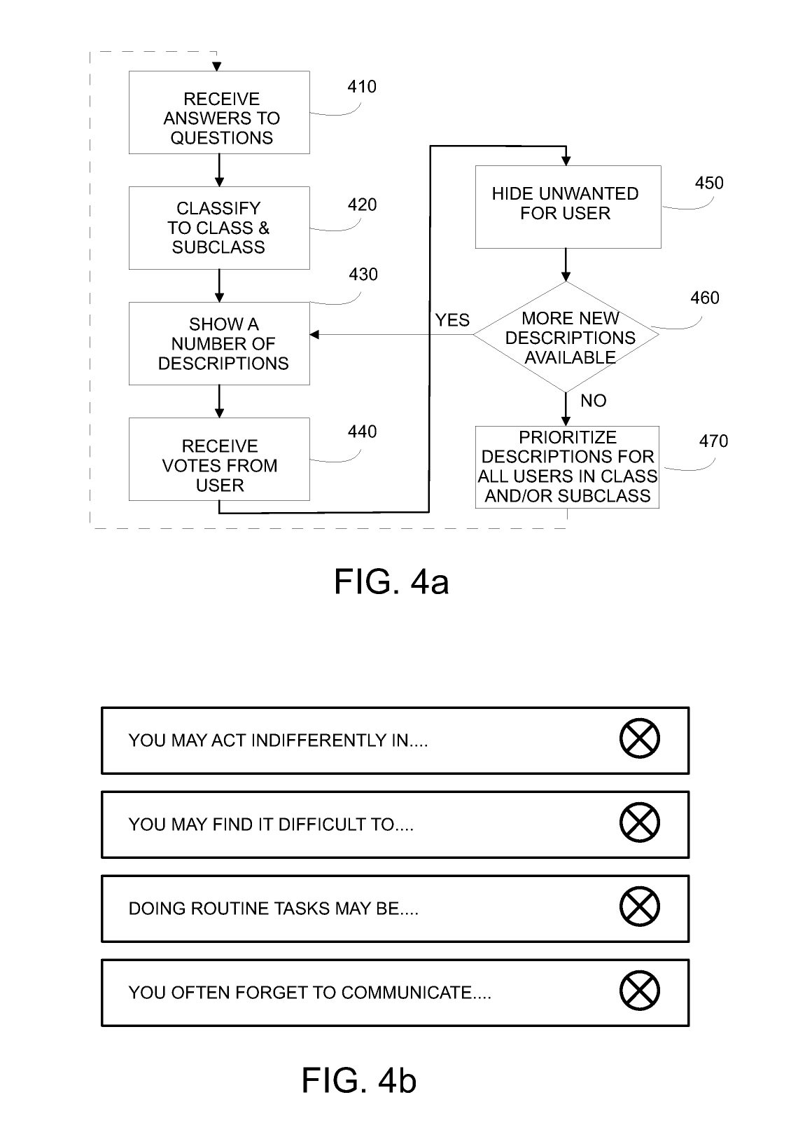

FIG. 4a shows a flow chart of producing adjustable output from a psychometric test according to an example embodiment. In phase 410, an individual user is presented questions. The questions may be presented one by one or in groups, in written format, or they may be presented using audio output means. In phase 420, the user is classified to a class and possibly a subclass. Based on the classification, a number of descriptions e.g. describing the user's behavior are presented to the user in phase 430. The presentation may happen visually or e.g. using audio output, or on paper.

In phase 440, the user is allowed to choose or vote on the presented descriptions. In the choosing or voting, a user may indicate that a particular description is not something that describes the user's behavior correctly, or that a description is a good one in this sense. If a user “votes away” a description, the description may not be shown to the user any more in phase 450. The same description may also receive a smaller presentation priority in phase 470, whereby it is shown less probably to other users in the same class and/or subclass, as well. If a description is removed from sight for a user, the system may in phase 460 check whether there are more descriptions available that can be shown to the user. If there are, the process continues from phase 430. The user may also “vote in” descriptions that he finds to be a good match, and the presentation priority of such descriptions may be increased in phase 470. The presentation priority may be dependent e.g. on the class, on the sub-class and on the language of each description. In other words, when the user votes on an item, the user's class and sub-class as well as the language of the description are used as a key, and the presentation priority is altered for the description in that class and sub-class. Alternatively or in addition, the presentation priority of the same description for neighboring classes and/or sub-classes may be adjusted.

FIG. 4b shows a user interface for adjusting output from a psychometric test according to an example embodiment. There may be a number of descriptions 480 shown to the user. When the user indicates e,g, by a mouse click or by dragging away a description that the description is not a preferred one, the description is removed from sight and its priority for users in the same class and subclass are lowered. In this manner, the output of the psychometric test may be adjusted even without adjusting the classification thresholds of the psychometric test. Feedback (voting) from the users may also be used to adjust the classification thresholds, e.g. if users consistently indicate that a description does not fit his behavior even though the description is known to have a good match for people in the class.

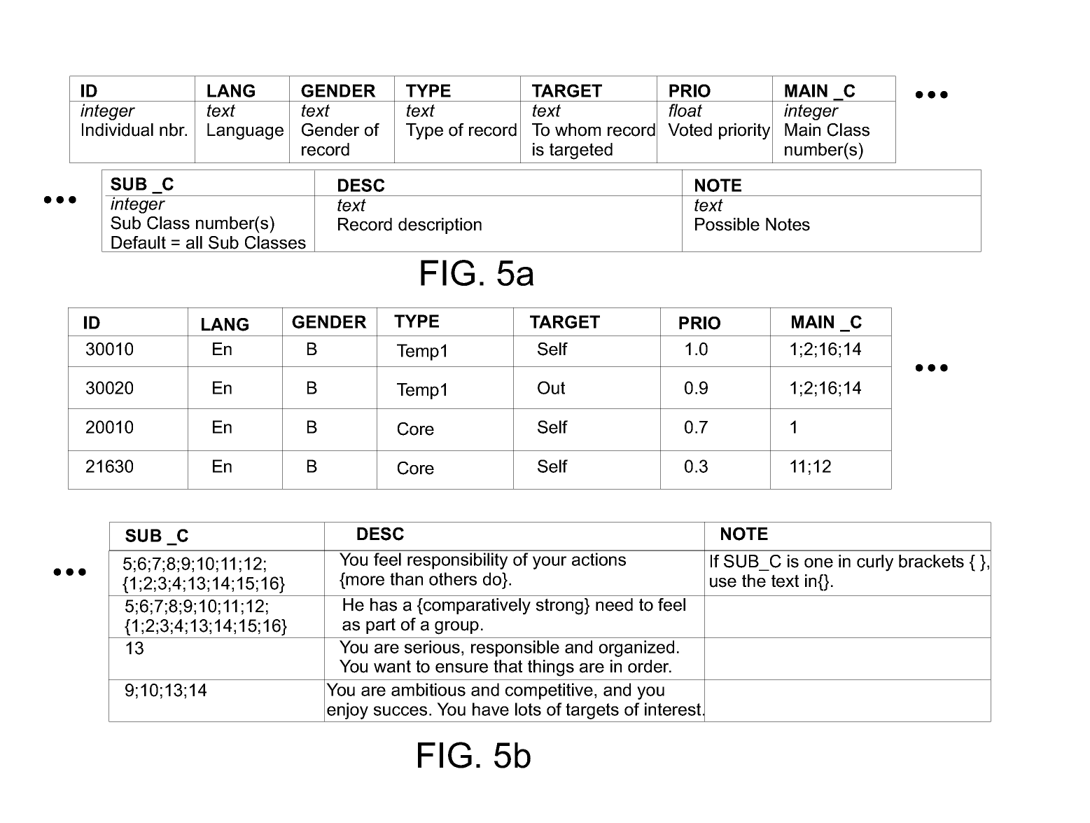

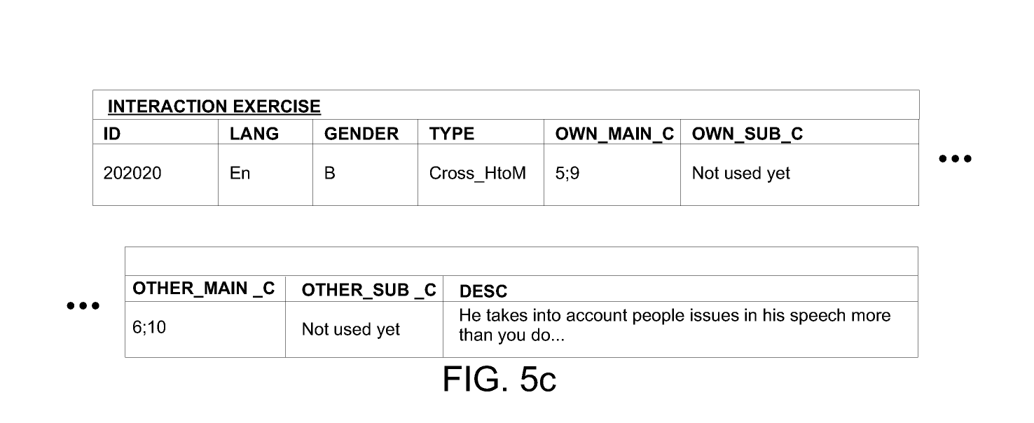

FIG. 5a shows a data structure for producing adjustable output from a psychometric test according to an example embodiment. The data structure may e.g. be a database, a collection of objects, or any other form in which data may be organized. In an example embodiment, the data structure is a record comprising fields. The fields and their data content are such that they are suitable for producing adjustable output. This may be arranged e.g. so that the key fields (ID, LANG, GENDER, TYPE, TARGET, PRIO, MAIN_C, SUB_C) may take a number of different values (or even a range of values), and the description field (DESC) provides a description suiting these values. In this manner, it may be possible to create textual descriptions for a large number of different combinations of the field values without excessive work for creating the adjustable descriptions. Since the key fields may have multiple values per one description, there are fewer different descriptions to produce than there are different key field value combinations.

The fields in FIGS. 5a, 5b and 5c are:
ID: an identifier for the description record, e.g. an integer
LANG: language of the description text, e.g. text
GENDER: gender of the description record, text (Male/Female/Both)
TYPE: type/related context of record, e.g. temp1 (temperament 1)
PRIO: priority of the description (see presentation priority earlier)
MAIN_C: main class of the record
SUB_C: sub-class of the record
DESC: description text
NOTE: a note on the record

In addition to the data structure providing for easier production of adjusted descriptions, the descriptions themselves may be flexibly adaptable based on the key field values. For example, the description field may comprise a text “You have a {high} tendency for creating harmony”, and if the SUB_C key field has the value “strong”, the word “high” is included in the description, otherwise it is omitted. The description texts may also have a variable portion whose content changes based on the value of a key field. FIG. 5b shows an example of data in a data structure for producing adjustable output from a psychometric test according to an example embodiment. The descriptions for different languages, classes and sub-classes (and other key fields) may comprise adjustable sections as described above, as well as a presentation priority, as explained earlier. Both these features may provide for the adjustment of the output of the system. This may make it possible for not to adjust the questions and/or classification, and only adjust the output. Alternatively, adjusting the output may be done in addition to adjusting the questions and/or the classification.

In FIG. 5b, the presentation priorities PRIO may be determined as follows. The presentation priority may be specific to a main class, a sub-class and a language, corresponding to the main class, sub-class and language of a single user. Therefore, there may be a record or line for each combination of main class, sub-class and language (such as the third line in FIG. 5b), thus making it possible to set a presentation priority for a description for each combination of class, sub-class and language separately. Alternatively, several combinations may share a presentation priority, such as indicated by the fourth line in FIG. 5b. For example, all the different sub-classes may share the same presentation priority. When a user having a certain main class, sub-class and language gives feedback such as voting (as shown in FIG. 4b and explained earlier), the presentation priority corresponding to that combination of class, sub-class and language may be altered. It needs to be appreciated that the internal representation of the data in FIG. 5b in a data structure may vary depending on implementation. The data in FIG. 5b may be split to all combinations of all key fields and the data fields such as presentation priority PRIO and description DESC may be different for all these records. Data pointers and other arrangements may be used to save space and to implement a more manageable data structure. For example, the presentation priority may be alterable individually for different combinations of class, sub-class and language. At the same time, the description fields of all the combinations having the same class and language may point to a single description that can be managed (edited) at once for all the sub-classes, for example using the adjustable description technique described earlier.

FIG. 5c shows an example of an output for applying psychometric testing for interaction according to an example embodiment. The record shown in FIG. 5c comprises key fields for two users that are interacting, and the description text therefore describes behavior in the interaction. In this situation, the problem of having to create a large number of description texts to cover all possible key field combinations for two users. The arrangement described above where key fields may take multiple values in a single record, and/or the description texts may be flexibly adjustable based on the field values allows the automatic production of adjusted output descriptions without excessive work in producing the description texts.

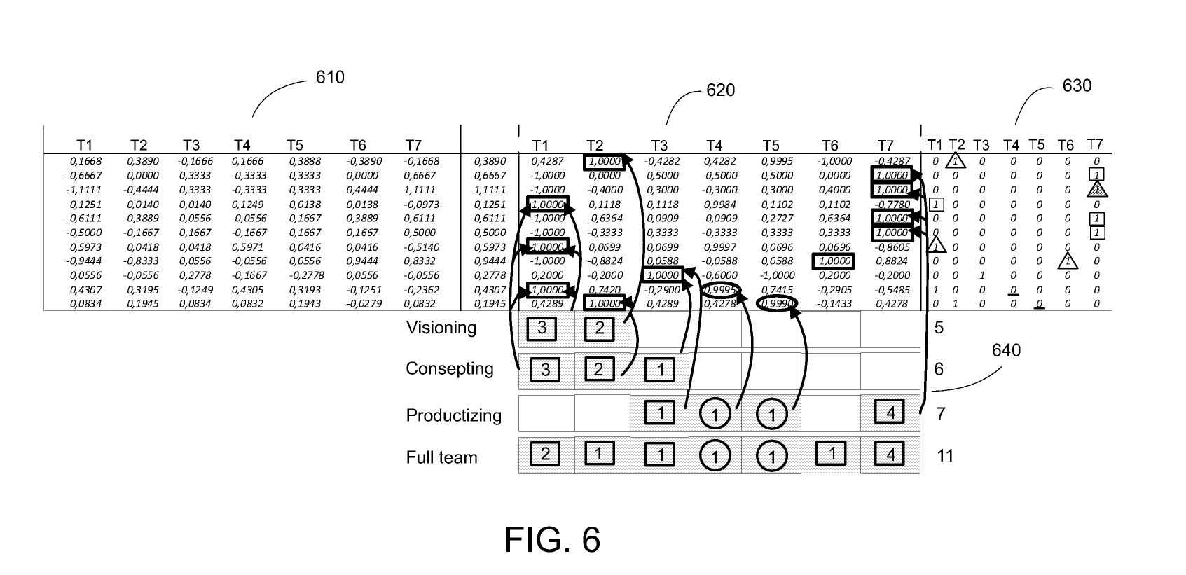

FIG. 6 shows a method of assigning people to team roles based on psychometric testing according to an example embodiment. In FIG. 6, the individual rows indicate psychometric team role characteristics of individual users—in this case, 11 users. The different team role preferences T1, T2, T3, T4, T5, T6 and T7 of a user may be obtained as a projection or combination of the classification of the user into classes (and sub-classes), e.g. the classes formed by the axes A, B, C and D. Each team role corresponds to a different combination of the psychometric axes/variables. For example, the team role T1 may require a low (negative) value on axis B, a high (positive) value on axis C and a low (negative) value on axis D. On the other hand, the team role T6 may require a high value (positive value) simultaneously on all axes. A psychometric distance or a team role vector may thus be formed for each user/person from the starting values A, B, C and D for the persons. For example, if a certain user has a simultaneously high value (positive value) for all axes A, B, C and D, he may get a high preference value for the team role T6, but at the same time he may get a low preference or probability for fitting the team role T1. This means that the user fits well to the team role T6 and fits quite badly for the team role T1. It needs to be appreciated that there may be any practical number of team roles, for example 2, 3, 4, 5, 6, 7, 8, 9 or 10, or even more than 10, e.g. 12 or 15. The number of team roles used may depend on the application where the system is used.

The section 610 shows the absolute preference values of the users for different team roles (T1, T2, . . . , T7) obtained in the manner described above. The section 620 shows the normalized preference values for different team roles. Normalization has been carried out here so that for each user the absolute values 610 have been divided by the largest absolute value for that user. The normalized preference values 620 are therefore between −1.0 and 1.0. It needs to be appreciated here, of course, that any scaling and range of values may be used here. The normalized team role preferences may be used to determine the flexibility of a user to act in other roles than the preferred team role. If a person's second role has a normalized value that is close to 1.0, that is, close to the normalized value of the most preferred role, the user may be understood to be flexible with respect to acting in either one of these two roles. If the normalized value is significantly lower, the user will not be very flexible in practice to assume the other role, and will most likely operate efficiently only in the most preferred team role.

The selection of people to team roles based on the normalized psychometric data 620 is described next. First, the people are assigned to roles for which they have the highest preferences, as shown in section 630. In some teams, all the necessary team roles may be filled in this manner, such as for the first two teams 640. In such a case, there is no need to re-assign any people to different roles. However, if some necessary team roles are left unoccupied, such as in the third team of FIG. 6, some people may need to be reassigned from their highest preference team role to another (unoccupied) team role. This assignment happens so that the person having the highest normalized preference (and therefore greatest flexibility) for the unoccupied team role is moved from his most preferred team role to the unoccupied team role. For example, in FIG. 6 and the third team, the 10^{th} person is reassigned to the T4 team role and the 11^{th} person is assigned to the T5 team role.

It needs to be appreciated that not all people need to be assigned to the team. For example, it may be desirable to have only one person in a certain team role. In this case, among the people that have finally been assigned to that team role, the person whose absolute preference is highest or a person whose absolute preference is high enough may be chosen for that role (marked with a triangle in section 630). In the third team, the 3^{rd} person is indicated to be chosen to the T7 role due to his high absolute preference for the role (1.1111).

The forming of the team through assignment of team roles to people may also take place based on the maximization of “total team value” calculated as a sum or a weighted sum of the absolute team role preferences for those roles that people are assigned to. In this maximization, there may be a limitation that people are not assigned to team roles to which they are not flexible (based on the normalized preferences).

In the manner described above, only the persons who have the smallest difference in preference between the most preferred and the second preferred team role are re-assigned because these people are the most flexible people to assume a different team role than their most preferred role. It has been noticed in this disclosure that such an arrangement is more likely to create teams that work well in practice, since people fit fairly well to their team roles, no people are assigned to team roles that are much less preferred than their most preferred role, and all the necessary roles are occupied.

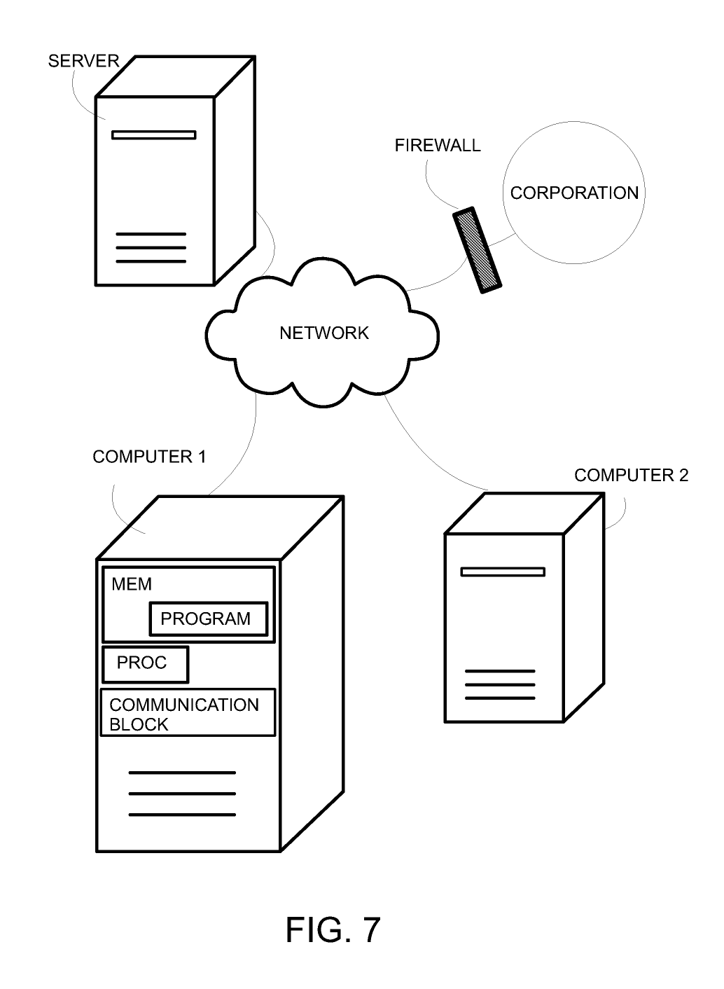

FIG. 7 shows a system and devices for psychometric testing according to an example embodiment. The test may be running on a server (SERVER) connected to a network (NETWORK) such as the internet. There may be multiple user computers (COMPUTER) connected to the network, too. There may also be a corporate computer network (CORPORATION) connected to the network e.g. via a firewall (FIREWALL). The various devices may comprise processors, memory, a communication element, and user interface means such as a display, keyboard, touch screen, loudspeaker etc. The network may be implemented as wireless or wired network of any kind, or a combination of technologies. The program or programs for carrying out the functionality of the above described embodiments may reside in the memory of a computer, a server, or distributed across multiple devices and/or the network, as a cloud service or any other practical means. Some of the computation may happen at one device, while user interface interaction may happen at the user computer.

The various embodiments can be implemented with the help of computer program code that resides in a memory and causes the relevant apparatuses to carry out the disclosed embodiments. For example, a user terminal device may comprise circuitry and electronics for handling, receiving and transmitting data, computer program code in a memory, and a processor that, when running the computer program code, causes the terminal device to carry out the features of an embodiment. Yet further, a network device may comprise circuitry and electronics for handling, receiving and transmitting data, computer program code in a memory, and a processor that, when running the computer program code, causes the network device to carry out the features of an embodiment. The various embodiments may be implemented as a network service embodied on a computer network, e.g. a cloud or a traditional client-server arrangement.

The various embodiments may also be at least partly implemented without the help of a computer. For example, paper-form questionnaires and computation forms may be used, and presentation of data to users may happen with the help of an expert person.

It is obvious that the present invention is not limited solely to the above-presented embodiments, but it can be modified within the scope of the appended claims.

What is claimed is:

1. A method for adjusting a psychometric test, the method comprising:
receiving input from a plurality of users, the input being indicative of a first psychometric variable and a second psychometric variable, the first and the second psychometric variables being essentially independent from each other,
classifying said users into at least four classes using said input and at least a first classification threshold for a first psychometric variable and at least a second classification threshold for a second psychometric variable, and
adjusting said first classification threshold to adjust the classification of said users into said classes so that at least one user is re-classified to a different class.

2. A method according to claim 1, comprising:
receiving said input from a plurality of users as responses to questions,
receiving modified input from at least one user as responses to modified questions, and
adjusting said first classification threshold for user in association to receiving said modified input.

3. A method according to claim 2, comprising:
modifying said questions by way of at least one of the group of translating a question to another language, re-wording an existing question, adding a question and deleting question.

4. A method according to claim 1, comprising:
defining at least one sub-threshold for said first psychometric variable for forming sub-classes, said sub-threshold being different than said threshold, and
classifying said users to said sub-classes using said sub-threshold.

5. A method according to claim 1, comprising:
presenting a plurality of descriptions to at least one said user according to said classification of said user into a class or a sub-class,
receiving a response from said at least one said user corresponding to a description, and
altering the priority of presentation of said description based on said response.

6. (canceled)

7. A method according to claim 5, wherein said priority of presentation of said description is altered for other users having at least one of the group of the same class, the same sub-class and the same language.

8. A method according to claim 1, wherein said adjusting is carried out by comparing said classification of users to another known classification of users.

9. A data structure for psychometric testing embodied on a non-transitory computer readable medium, said data structure comprising data elements for controlling a computer to:
receive input from a plurality of users, the input being indicative of a first psychometric variable and a second psychometric variable, the first and the second psychometric variables being essentially independent from each other, and
classify said users into at least four classes using said input and at least an adjusted first classification threshold for a first psychometric variable and at least a second classification threshold for a second psychometric variable, wherein said adjusted first classification threshold having been adjusted to adjust classification of said users into said classes so that at least one user is re-classified to a different class than without said adjustment of said first classification threshold,
wherein said data structure having been adjusted based on input from users.

10. A data structure according to claim 9, comprising
descriptions associated with said classes for presenting said descriptions to said users, and
priority of presentation values for said descriptions, said priority of presentation values having been formed based on input from users.

11. A computer program product embodied on a non-transitory computer readable medium, comprising computer program code which, when executed on a processor, causes a computer or a system to:
receive input from a plurality of users, the input being indicative of a first psychometric variable and a second psychometric variable, the first and the second psychometric variables being essentially independent from each other,
classify said users into at least four classes using said input and at least a first classification threshold for a first psychometric variable and at least a second classification threshold for a second psychometric variable, and
adjust said first classification threshold to adjust the classification of said users into said classes so that at least one user is re-classified to a different class.

12. A system for adjusting a psychometric test, comprising:
a computer configured to receive input from a plurality of users, the input being indicative of a first psychometric variable and a second psychometric variable, the first and the second psychometric variables being essentially independent from each other,
a computer configured to classify said users into at least four classes using said input and at least a first classification threshold for a first psychometric variable and at least a second classification threshold for a second psychometric variable, and
a computer configured to adjust said first classification threshold to adjust the classification of said users into said classes so that at least one user is re-classified to a different class.

13. A method for psychometric testing, comprising:
receiving input from a plurality of users, the input being indicative of a first psychometric variable and a second psychometric variable, the first and the second psychometric variables being essentially independent from each other,
classifying said users into at least four classes using said input and at least a first classification threshold for a first psychometric variable and at least a second classification threshold for a second psychometric variable,
presenting a plurality of descriptions to at least one said user according to said classification of said user into a class,
receiving a response from said at least one said user corresponding to a description, and
altering the priority of presentation of said description based on said response.

14. (canceled)

15. A method according to claim 13, wherein said priority of presentation of said description is altered for other users having at least one of the group of the same class, the same sub-class and the same language.

16. A method according to claim 13, comprising:
defining at least one sub-threshold for said first psychometric variable for forming sub-classes, said sub-threshold being different than said threshold, and
classifying said users to said sub-classes using said sub-threshold.

17. A method according to claim 13, comprising
forming a collaboration description based on a classification of a first said user and a second said user, and
presenting said collaboration description to said first user.

18. A method according to claim 13, comprising
determining a team role preference for a group of said users based on said classification, said group of said users comprising a first, second and a third user,
providing an association of said first user to a first team role based on a first preference of said first user to said first team role, and
providing an association of said second user to a second team role based on said second user having a higher second preference to said second team role compared to a second preference of said third user to said second team role,
wherein said second user has a higher first preference to said first team role compared to the second preference to said second team role.

19. A computer program product embodied on a computer readable medium, comprising computer program code which, when executed on a processor, causes a computer or a system to carry out the method according to claim 12.

20. (canceled)

21. A system for psychometric testing, comprising at least one computer and at least one user terminal in a network setting, said system comprising computer program code that, when executed, causes said computer and said at least one user terminal to:
receive input from a plurality of users, the input being indicative of a first psychometric variable and a second psychometric variable, the first and the second psychometric variables being essentially independent from each other,
classify said users into at least four classes using said input and at least a first classification threshold for a first psychometric variable and at least a second classification threshold for a second psychometric variable,
present a plurality of descriptions to at least one said user according to said classification of said user into a class,
receive a response from said at least one said user corresponding to a description, and
alter the priority of presentation of said description based on said response.

22. A system for psychometric testing, comprising at least one computer and at least one user terminal in a network setting, said system comprising computer program code that, when executed, causes said computer and said at least one user terminal to carry out the method according to claim 12.

23. A network service embodied on at least one computer in a networked setting, said network service being, when requested by a user, configured to:
receive input from a plurality of users, the input being indicative of a first psychometric variable and a second psychometric variable, the first and the second psychometric variables being essentially independent from each other,
classify said users into at least four classes using said input and at least a first classification threshold for a first psychometric variable and at least a second classification threshold for a second psychometric variable,
present a plurality of descriptions to at least one said user according to said classification of said user into a class,
receive a response from said at least one said user corresponding to a description, and
alter the priority of presentation of said description based on said response.
